(19) United States
(12) Patent Application Publication
(10) Pub. No.: US 2010/0024223 A1
(43) Pub. Date: Feb. 4, 2010

(54) Cast saw

(76) Inventors: Jonathan Lehman, Goshen, IN (US); Benjamin Lehman, Goshen, IN (US)

Correspondence Address: R. TRACY CRUMP, P.O. BOX 604, 32790 DUNN ROAD, NEW CARLISLE, IN, 46552, US

(21) Appl. No.: 12/220,864

(22) Filed: Jul. 29, 2008

(51) Int. Cl. B26D 7/01

(52) U.S. Cl. 30/374

(57) ABSTRACT

The cast saws embodying this invention include an ergonomic egg shaped saw body and a spiral cut blade, which eliminates the exposed circular blade of conventional cast saws. The spiral cut blade extends from the bottom of the saw body. The spiral cut blade is driven by an electric DC drive motor, which is housed within the saw body along with batteries and other electronics and wiring. A blade shield is pivotally mounted to the saw body, which covers the spiral cut blade when not in use. The shield pivots upward against the saw body as the cast saw moves over and cuts the cast from the patient. A guide assembly extends from the bottom of the saw body, which includes a thin neck part and a flat foot plate. The foot plate acts as a guide, which travels between the patient's skin and the inside layer of gauze of the cast. The foot plate also ensures that the spiral cut blade never contacts the patient's skin.

This invention relates to a cast saw, and in particular spiral cut cast saws.

### BACKGROUND AND SUMMARY OF THE INVENTION

Cast saws are well known in the medical profession. The design of a cast saw has changed little since first being developed to cut through the plaster and other hardened cast materials. A conventional cast saw comprises a cylindrical metal body housing the saw motor and an exposed vibrating or reciprocating circular blades extending from the end of the saw body. The physician simply grasped the saw by the cylindrical body and uses the vibrating blade to cut away the cast from the patient.

While generally safe, conventional cast saws have an ominous appearance and can cause skin burns. Conventional cast saws cut through the cast materials in an up and down stepped action and the circular blade frequently contacts the patient's skin. The cutting action cause the blade to become hot and even with experienced operators the contact between the blade and the patient's skin often results in skin burns. Moreover, the visibly exposed circular blade is naturally unsettling to patients, particularly children. The cutting action of the vibrating circular blade also creates considerable noise, vibrations and cast dust, which further adds to the patient's anxiety while a cast is removed.

The cast saw embodying the present invention provides an ergonomically improved design, which eliminates the exposed circular blade of conventional cast saws. The cast saws embodying the present invention include an egg shaped saw body and a spiral cut blade, which extends from the bottom of the saw body. The spiral cut blade is driven by an electric DC drive motor, which is housed within the saw body along with batteries and the other saw electronics and wiring. A blade shield is pivotally mounted to the saw body, which covers the spiral cut blade when not in use. The shield pivots upward against the saw body as the cast saw moves over and cuts the cast from the patient. A guide assembly extends from the bottom of the saw body, which includes a thin neck part and a flat foot plate. The foot plate acts as a guide, which travels between the patient's skin and the inside layer of gauze of the cast. The foot plate also ensures that the spiral cut blade never contacts the patient's skin.

The operation and appearance of the cast saws of this invention is safer and much less ominous and imposing to patients than conventional cast saws. The spiral cut blade used by the cast saws of this invention never comes in contact with the patient's skin eliminating skin burns and the possibility of other injury, The cast saw embodiments of this invention are ideally suited for children who may be traumatized by the noise, vibration and debris created by conventional cast saws, as well as the imposing appearance of an exposed blade used by conventional cast saws. The spiral cut blades used by this invention generates significantly less noise, vibration and cast dust than conventional cast saws. In addition to being more ergonomic, the shape of the saw body of these saws are more futuristic and less industrial in appearance than conventional cast saws. Unlike conventional cast saws where the circular blade is exposed and visible, the spiral cut blades used by the cast saw embodiments of this invention are visibly concealed from the patient by the pivoting blade shields. Patients see nothing of the cutting action of the cast saws of this invention. More importantly, the foot plate ensures that the spiral cut blade never contacts the patient's skin.

These and other advantages will become apparent upon a reading of the following description.

### BRIEF DESCRIPTION OF THE DRAWINGS

The preferred embodiments of the invention have been depicted for illustrative purposes only wherein:

FIG. 1 is a perspective view of one cast saw embodiment of this invention;

FIG. 2 is a perspective view of the blade shield of the cast saw of FIG. 1;

FIG. 3 is a side view of the cast saw of FIG. 1;

FIG. 4 is a perspective view of a second cast saw embodiment of this invention;

FIG. 5 is a partial front view of the cast saw of FIG. 4;

FIG. 6 is a partial side view of the cast saw of FIG. 4 showing the pivoting guide assembly;

FIG. 7 is a side view of the cast saw of FIG. 4;

FIG. 8 is a perspective view of a third cast saw embodiment of this invention;

FIG. 9 is a front view of the cast saw of FIG. 8;

FIG. 10 is a partial side view of the cast saw of FIG. 8 showing the detachable guide assembly;

FIG. 11 is a side view of the cast saw of FIG. 8;

FIG. 12 is a side view of the cast saw of FIG. 1 and a charging stand;

FIG. 13 is a partial side view of the cast saw of FIG. 6 cutting through a cast; and

FIG. 14 is a partial perspective view of the cast saw of FIG. 6 cutting through a cast on a patient's arm.

### DESCRIPTION OF THE PREFERRED EMBODIMENTS

The embodiments herein described are not intended to be exhaustive or to limit the invention to the precise form disclosed. They are chosen and described to explain the invention so that others skilled in the art might utilize its teachings.

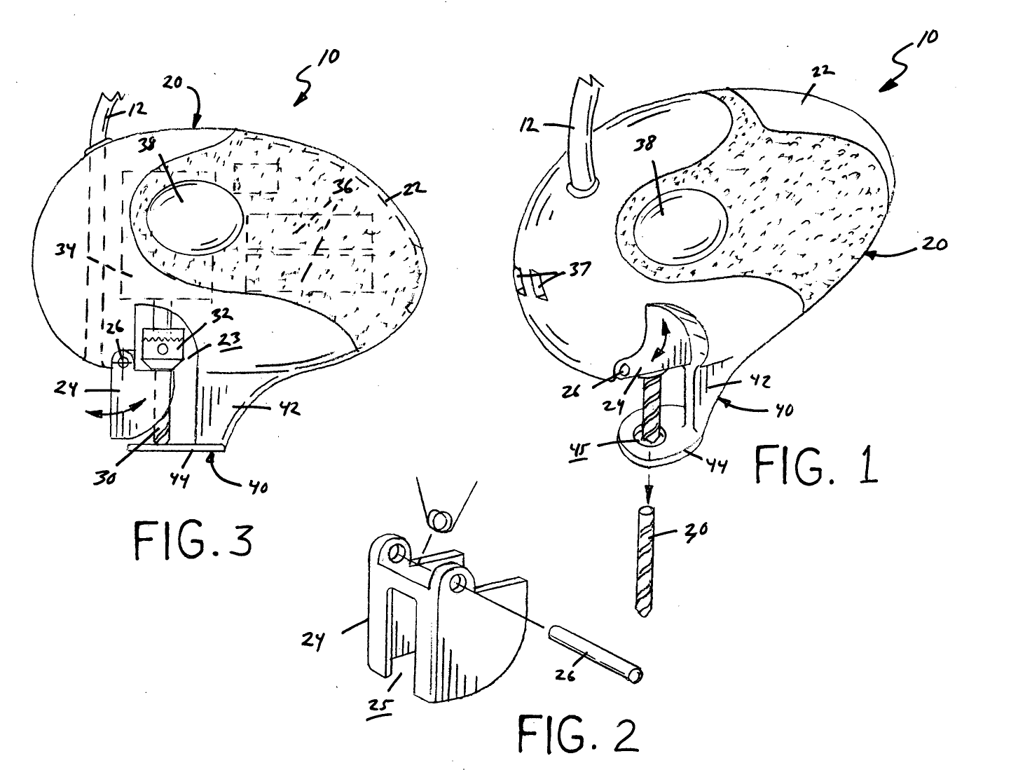

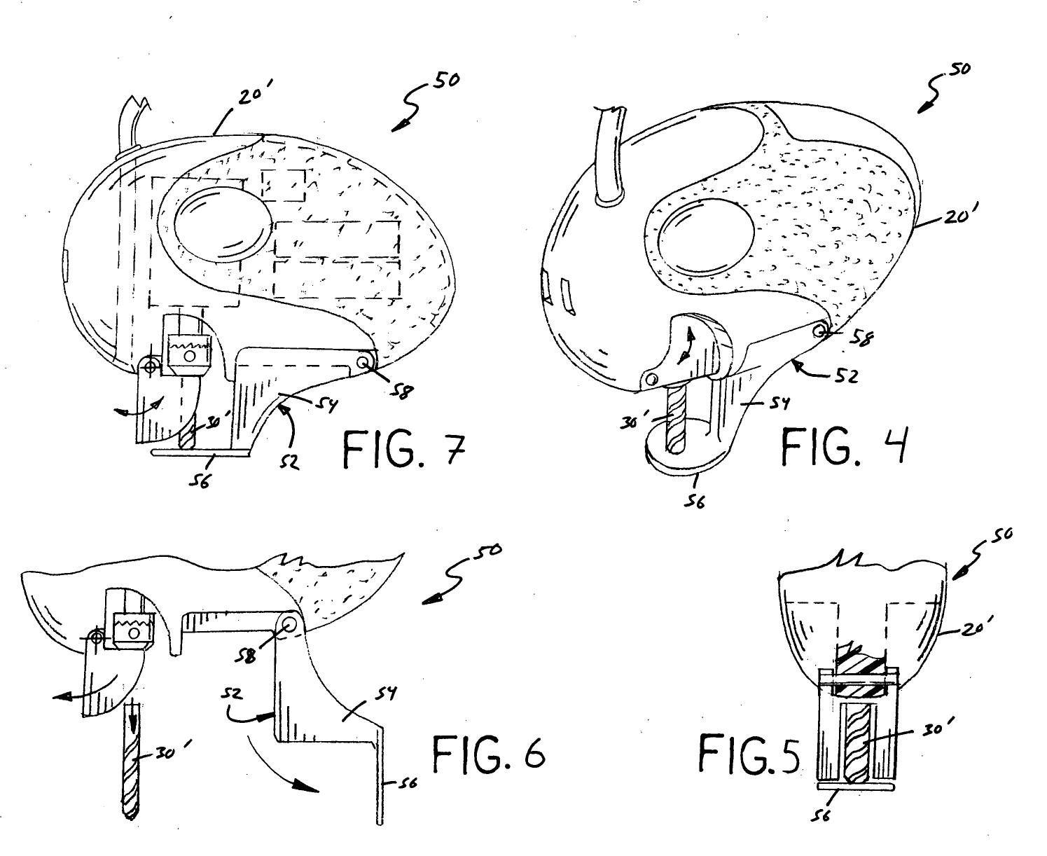

FIGS. 1-3, 12-14 illustrate a first cast saw embodiment of this invention, which is designated generally as reference numeral 10. As shown, saw 10 includes an egg shaped saw body and a spiral cut blade 30, which is also known as a rotary cut blade. Saw body 20 is configured in an ergonomic egg shape so that the saw body can be comfortably grasped and controlled during the cutting operation. As shown, saw body 20 has rounded front and aft ends. The sides of saw body 20 are also textured to provide a positive grip for the operator. A blade shield 24 is pivotally mounted to saw body 20. Blade shield 24 covers spiral cut blade 30 when not in use and pivots upward against the saw body 20 as cast saw 10 moves over and cuts a cast 4. Blade shield 24 has an arcuate body, which mates with the bottom of saw body 20. Blade shield 24 is mounted to saw body 20 by a pin 26 that extends through bores in the saw body and shield. Blade shield 24 also has a vertical slot 27, through which spiral cut blade 30 extends when the shield is pivoted upward against saw body 20.

Spiral cut blade 30 is driven by an electric DC drive motor 34 powered by a pair of batteries 36, which are housed within the saw body interior 21 along with other saw electronics and wiring. Batteries 36 are accessible through a battery cover 22, which forms part of saw body 20. Cast saw 10 is also adapted to be used with a charging station 70, which is illustrated FIG. 10 and described with use with another cast saw embodiment of this invention. Saw body 20 includes electrical contacts 37, which couple with electrical contacts 76 of charging station 70 to recharge batteries 36. The motor is actuated by a push button 38 located on the left side of saw body 20. Ideally, drive motor 34 is an electric motor selected to turn spiral cut blade 30 at a speed and torque sufficient to cut any variety of cast materials at various thicknesses. As shown, drive motor 34 is vertically oriented within saw body 20 so that spiral cut blade 30 extends vertically from the saw body. Spiral cut blade 30 is coupled to drive motor 34 by a conventional bit chuck 32. The bottom of saw body 20 has an opening 23, which provides access to bit chuck 32 for allowing spiral cut blade 30 to be replaced. The helical flutes of spiral cut blade 30 are designed to quickly cut through cast materials.

The first embodiment of cast saw 10 uses an integral guide assembly 40 extends from the bottom of saw body 20 adjacent its aft end. Guide assembly 40 includes a thin neck part 42 and a flat foot plate 44. Foot plate 44 provides the guide surface which contacts the patient's skin as the cast saw moved over the patient's skin and cuts the cast material. Foot plate 44 also ensures that the spiral cut blade 30 never contacts the patient's skin. As shown, neck part 42 is relatively thin, with its cross-sectional diameter being approximately equal to or less than the cut diameter of spiral cut blade 30. The profile of neck part 42 is also configured to allow cast saw 10 to cut in a slightly curved cut path. Foot plate 44 has a bore 45, through which spiral cut blade 30 can pass to facilitate blade replacement.

Cast saw 10 can also be connected to an external vacuum line 12 to allow cast dust to be drawn and collected from the cutting area. Vacuum line 12 connects to a port (not shown) extending from the top of saw body 20 and communicated through an internal vacuum passage through the forward end of the saw body, which opens just forward of spiral cut blade 30. Alternatively, the cast saws of this invention can be modified to incorporate an internal dust collection mechanism. The drive motors can be modified to create a vacuum, which can draw cast dust into a dust collection area within the saw body.

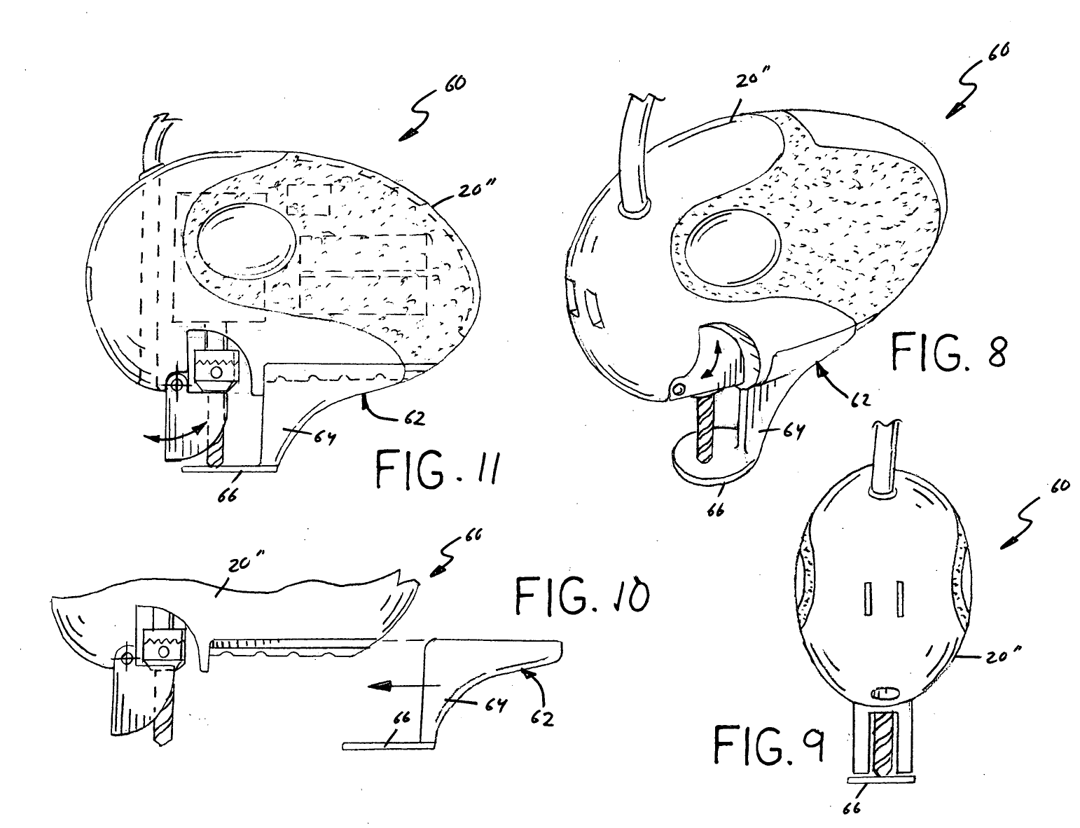

FIGS. 4-7 illustrate a second cast saw embodiment, designated generally as reference numeral 50, having a pivoting guide assembly 52. Similar to the guide assembly of cast saw 10. Guide assembly 52 includes a neck part 54 and a foot plate 56. Guide Assembly 52 is pivotally mounted to saw body 20′ by a pivot pin 58. As shown in FIG. 5, foot plate 56 swings away from spiral cut blade 30′ to allow for convenient blade replacement. Neck part 54 and saw body 20′ are configured so that guide assembly 52 is held against the saw body in the operating position (FIGS. 3 and 4) by a snap fit connection.

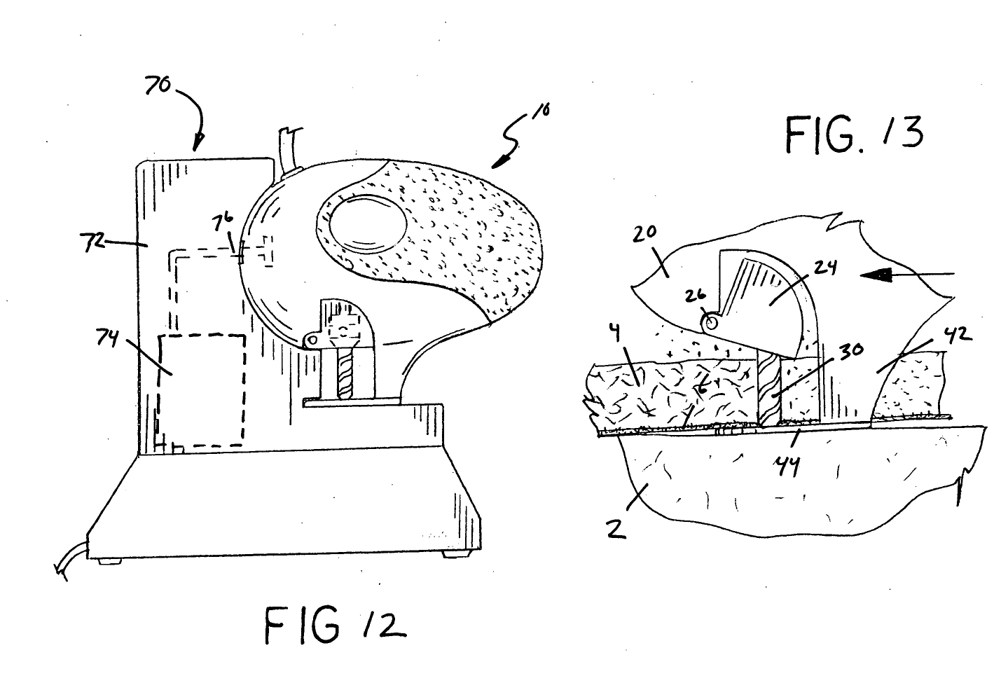

FIGS. 8-11 illustrate a third cast saw embodiment, designated generally as reference numeral 60, having a detachable guide assembly 62. Again, detachable guide assembly 62 includes a neck part 64 and a foot plate 66. Neck part 64 and saw body 20″ are adapted and configured to have mating grooves and flanges so that neck part 64 slides onto the saw body and is secured by a snap fit connection. A safety fastener (not shown) can be threaded through neck part 64 into saw body 20″ to ensure that guide assembly 62 is securely held to saw body 20″ during operation.

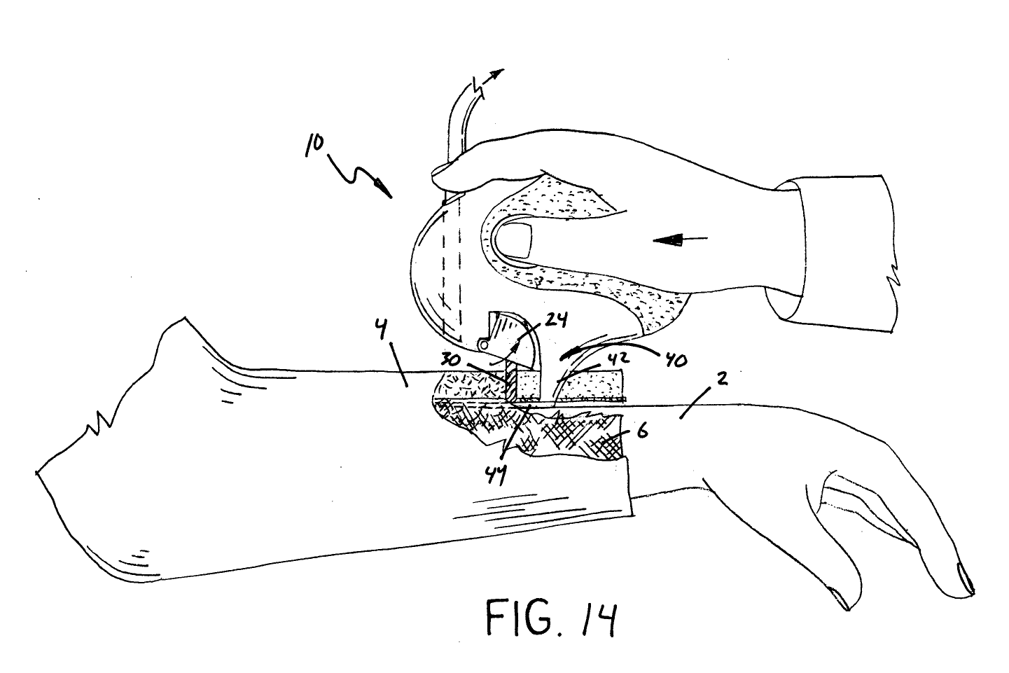

FIG. 12 illustrates cast saw 10 seated within a charging station 70, which allows the internal batteries (not shown) of cast saw 60 to be recharged. Charging station 70 includes a saw dock 72 and a power charger/converter 74. Saw dock 72 is configure to receive cast saw 10. Saw dock 72 includes electrical contact 76, which engage the contract 37 of cast saw 10. While each cast embodiment of this invention is illustrated and described as being driven by a DC electrical motor powered by rechargeable internal batteries, these embodiment can be modified to use conventional single use DC batteries. In addition, the cast saw embodiment of this invention can also be modified to use AC electric motors and power cords connected to AC electrical outlets or any other motor drive means within the scope of the teachings of this invention.

FIGS. 13 and 14 illustrate cast saw 10 in use cutting a cast 4 from a patient's arm 2. As shown, the operator's hand grasps cast saw 10 within hand overlying saw body 20. As shown, foot plate 66 moves under cast 4 between the patient's arm 2 and the gauze layer 6. As the operator moves cast saw 10 over cast 4 and blade removes the thin strip of cast material cutting the cast, blade shield 24 is pivoted upward against saw body 20. Cast dust 8 from the cutting action is collected within the gauze layer or evacuated from the cutting area through vacuum passage (not shown) within the saw body into the vacuum line 12. As shown, only foot plate 44 contacts the patient's skin. As shown, neck part 42 is thin enough to pass through the slit cut in cast 4 by the cutting action of blade 20.

One skilled in the art will note that the cast saws of this invention offer several advantages over conventional cast saws. The shape of the saw body is more futuristic and less industrial in appearance than conventional cast saws. The egg shaped saw body used by the various cast saw embodiments are more ergonomic for the operator. The saw bodies fits naturally in the operator's hand so that the operator can move the cast saws over the cast. The cast saws can be safely operated with a single hand with the saw control buttons conveniently located on the saw body within easy access to the operator's hand. The cast saws of this invention is well balanced with the drive motor and batteries located directly over the spiral cut blade. With its weight evenly distributed forward and aft, the cast saw can stand upright on the foot plate when not in use. The cast saws of this invention can be powered by AC electric power using a power cord or DC electric power using internal batteries. The design of the saw body also allows for the cast saw to be docketed in a charging housing, where electrical contacts on the front of the saw body engage electrical contacts in the charging housing to recharge the cast saw's internal batteries. The spiral cut blade generates less noise, vibration and cast dust than conventional cast saws. The direction of the blade rotation along with the configuration of the blade flutes discharge cast particulate and dust downward into the layer of gauze and padding between the cast material and the patient's skin. With most of the cast particulate and dust captured in the cast gauze and padding, little airborne dust is expelled into the work area.

It is important to note that the operation and appearance of the cast saws embodying this invention are safer and much less ominous and imposing to patients. Only the foot plate contacts the patient's skin. The foot plate ensures that the spiral cut blade never contacts the patient's skin. In addition to acting as a physical barrier between the patient's skin and the blade, the foot plate also acts as a thermal shield for the blade, which may get hot during use. Unlike conventional cast saws where the circular blade is exposed and visible, the spiral cut blade used by the cast saws of this invention is completely concealed from the patient by the pivoting blade shield. Where patients see the exposed circular blades and the cast dust dispelled from the cutting action of conventional cast saws, patients only see the operator's hand moving the cast saw over the cast. The spiral cut blade extends beneath the saw body out of the patients' sight when cutting the cast material. When not cutting the cast, the spiral cut blade is completely shielded from view by the pivoting blade shield. The patients see nothing of the cutting action of these cast saws. The patient hears only the slight hum and feels only the minor vibrations of the spiral cut blade removing a thin line of cast material. Consequently, the cast saws of this invention are ideally suited for children who may be traumatized by the noise, vibration and debris created by conventional cast saws, as well as the imposing appearance of an expose spinning circular blade used by conventional cast saws.

It should also be noted that the learning curve for operating the cast saws of this invention is less steep than for conventional cast saws. The dangers associated with the exposed circular blades of conventional cast saws are operator dependant but are always present to some degree regardless of the operator's experience. Conventional cast saws require a stepped up and down movement of the vibrating circular blade across the cast, which requires caution to prevent skin burns as the blade contacts the patient's skin. The cast saws of this invention are safer and much easier to operate. The cast saws of this invention eliminate the stepped up and down cutting movement and greatly increases the speed at which a cast can be removed from a patient. Cutting with greater speed with greater safety is an advantage for a busy medical practice.

It is understood that the above description does not limit the invention to the details given, but may be modified within the scope of the following claims.

1. A cast saw for cutting casts from a patient comprising:
an egg shaped housing adapted to be held by a human hand, the housing having an interior defined therein and having a top, a bottom, a front end and an aft end;
an electrical motor disposed within the housing;
a spiral saw blade adapted for operable connection to the motor and extending from the housing bottom between the housing front end and the housing aft end; and
a guide assembly extending from the housing, the guide assembly includes a neck part extending from the housing bottom adjacent the housing aft end and a foot plate mounted to the neck part so that the blade extends from the housing bottom over the foot plate, the foot plate being spaced from the housing bottom and centered substantially between the housing front end and the housing aft end so that the cast saw is substantially balanced when supported and resting atop the foot plate.

2. The cast saw of claim 1 and a blade shield pivotally mounted to the housing for movement between a first position covering the blade and a second position pivoted away from the blade to expose the blade.

3. (canceled)

4. The cast saw of claim 1 wherein the guide assembly is detachably connected to the housing.

5. The cast saw of claim 3 wherein the foot plate is pivotally connected to the neck part to permit access to the blade.

6. The cast saw of claim 3 wherein the foot plate has a hole therein to allow access to the blade.

7. The cast saw of claim 1 and a battery disposed within the housing interior.

8. The cast saw of claim 1 wherein the housing is egg shaped,

9. A cast saw for cutting casts from a patient comprising:
an egg shaped housing adapted to be held by a human hand, the housing having an interior defined therein and having a top, a bottom, a front end and an aft end;
an electrical motor disposed within the housing;
a spiral saw blade adapted for operable connection to the motor and extending from the housing bottom between the housing front end and the housing aft end;
a guide assembly extending from the housing, the guide assembly includes a neck part extending from the housing bottom adjacent the housing aft end and a foot plate mounted to the neck part 50 that the blade extends from the housing bottom over the foot plate, the foot plate being spaced from the housing bottom and centered substantially between the housing front end and the housing aft end so that the cast saw is substantially balanced when supported and resting atop the foot plate; and
a blade shield pivotally mounted to the housing for movement between a first position covering the blade and a second position pivoted away from the blade to expose the blade.

10. In combination, an electric cast saw for cutting casts from a patient and a recharging station, the cast saw comprising:
an egg shaped housing adapted to be held by a human hand, the housing having
an interior defined therein and having a top, a bottom, a front end and an aft end; an electrical motor disposed within the housing; rechargeable batteries disposed within the housing for driving the motor; electrical contacts mounted to the housing and operatively connected to the batteries; a spiral saw blade adapted for operable connection to the motor and extending from the housing bottom between the housing front end and the housing aft end; a guide assembly extending from the housing, the guide assembly includes a neck part extending from the housing bottom adjacent the housing aft end and a foot plate mounted to the neck part so that the blade extends from the housing bottom over the foot plate, the foot plate being spaced from the housing bottom and centered substantially between the housing front end and the housing aft end so that the cast saw is substantially balanced when supported and resting atop the foot plate; and a blade shield pivotally mounted to the housing for movement between a first position covering the blade and a second position pivoted away from the blade to expose the blade;
and the recharging station comprising:
a dock adapted to receive the cast saw and an electrical power converter operatively connectable to an electrical power source, the dock having electrical contacts, which mate with the electrical contacts of the cast saw to allow the batteries to be recharged.
